(19) United States
(12) Patent Application Publication
(10) Pub. No.: US 2022/0322712 A1
(43) Pub. Date: Oct. 13, 2022

(54) EVAPORATION MODULE FOR PRODUCING CONCENTRATE, AND LIQUID PRODUCT MANUFACTURING SYSTEM INCLUDING SAME

(71) Applicant: CJ CHEILJEDANG CORPORATION, Seoul (KR)

(72) Inventors: Seung Yun YIM, Suwon-si, Gyeonggi-do (KR); Jin Hee HAN, Suwon-si, Gyeonggi-do (KR)

(73) Assignee: CJ CHEILJEDANG CORPORATION, Seoul (KR)

(21) Appl. No.: 17/640,868

(22) PCT Filed: Sep. 25, 2020
(86) PCT No.: PCT/KR2020/013066

§ 371 Date: Mar. 7, 2022

(30) Foreign Application Priority Data
Sep. 27, 2019 (KR) 10-2019-0119270

(51) Int. Cl. A23L 5/20; B01D 61/02; A23L 3/16

(52) U.S. Cl. CPC A23L 5/21; B01D 61/025; A23L 3/16

(57) ABSTRACT

A liquid product manufacturing system according to the present invention includes: a pretreatment module for processing input material; an evaporation module for producing a concentrate by concentrating juice obtained by processing organisms contained in the input material in the pretreatment module; an extraction module for extracting a fragrance material from a slurry further obtained by processing the organisms in the pretreatment module; and a productization module for producing a liquid product by mixing the concentrate and the fragrance substance.

### TECHNICAL FIELD

The present invention relates to an evaporation module for manufacturing concentrate, and a system for manufacturing a liquid product.

### BACKGROUND ART

To produce an edible product formed in a liquid state, such as a source, it is possible to obtain concentrate that is a liquid material by heating and filtering a given material.

However, when the concentrate is to be generated only by simply heating a liquefied material liquid, it may be difficult to obtain the concentrate of a desired concentration. In particular, when the concentrate is to be obtained at once by heating a large amount of material liquid, it may take excessively much time in a concentration process.

Meanwhile, when the product is produced in the scheme, fragrances that revives unique fragrance or tastes of the material may be flown or modified to disappear in the manufacturing process.

To complement the problems, it is possible to manufacture a product having an improved fragrance in a scheme of adding an existing fragrance material to the concentrate.

However, when the existing fragrance material is added to the concentrate, a product that does not agree with the natural fragrance of the material used for manufacturing the concentrate may be produced so that a dissimilar feeling may be given to a consumer who takes the product.

### DISCLOSURE

### Technical Problem

The present invention has been made to solve the above-mentioned problems, and provides an evaporation module for efficiently manufacturing concentrate, and a system for manufacturing a liquid product, to which a fragrance is added, by using the same.

### Technical Solution

A system for manufacturing a liquid product according to an embodiment of the present invention includes a pretreatment module that treats a material that is introduced, an evaporation module that generates concentrate by concentrating juice obtained by treating an wet material included in the introduced material in the pretreatment module, an extraction module that extracts a fragrance material from slurry further obtained by treating the wet material in the pretreatment module, and a productization module that generates the liquid product by mixing the concentrate and the fragrance material.

An evaporation module for concentrating juice obtained from an wet material into concentrate for producing a liquid product according to an embodiment of the present invention includes a thin film concentrator that forms intermediate concentrate by heating the juice and concentrating the juice through a scheme of forming a thin film, and a plate concentrator that generates the concentrate by further concentrating the intermediate concentrate concentrated in the thin film concentrator in a scheme of exchanging heat of the intermediate concentrate with a plurality of plates while causing the intermediate concentrate to pass between the plurality of plates.

### Advantageous Effects

Accordingly, concentrate may be efficiently produced.

A liquid product having a reduced dissimilar feeling and an improved fragrance may be produced by producing evaporation liquid and a fragrance material in one system.

### DESCRIPTION OF DRAWINGS

FIG. 1 is a conceptual view of a system for manufacturing concentrate according to an embodiment of the present invention;

FIG. 2 is a view illustrating flows of a process of treating an wet material in a system for manufacturing concentrate according to an embodiment of the present invention:

FIG. 3 is a view illustrating flows of a process of treating a dry material or all materials in a system for manufacturing concentrate according to an embodiment of the present invention;

FIG. 4 is a view illustrating a structure of a thin film concentrator according to an embodiment of the present invention; and

FIG. 5 is a perspective view of a plate concentrator according to an embodiment of the present invention.

### MODE FOR INVENTION

Hereinafter, some embodiments of the present invention will be described in detail with reference to the exemplary drawings. Throughout the specification, it is noted that the same or like reference numerals denote the same or like components even though they are provided in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. The terms are provided only to distinguish the components from other components, and the essences, sequences, orders, and the like of the components are not limited by the terms. When it is described that one element is connected, coupled, or electrically connected to another element, the element may be directly connected or coupled to the other element, but a third element may be connected, coupled, or electrically connected between the elements.

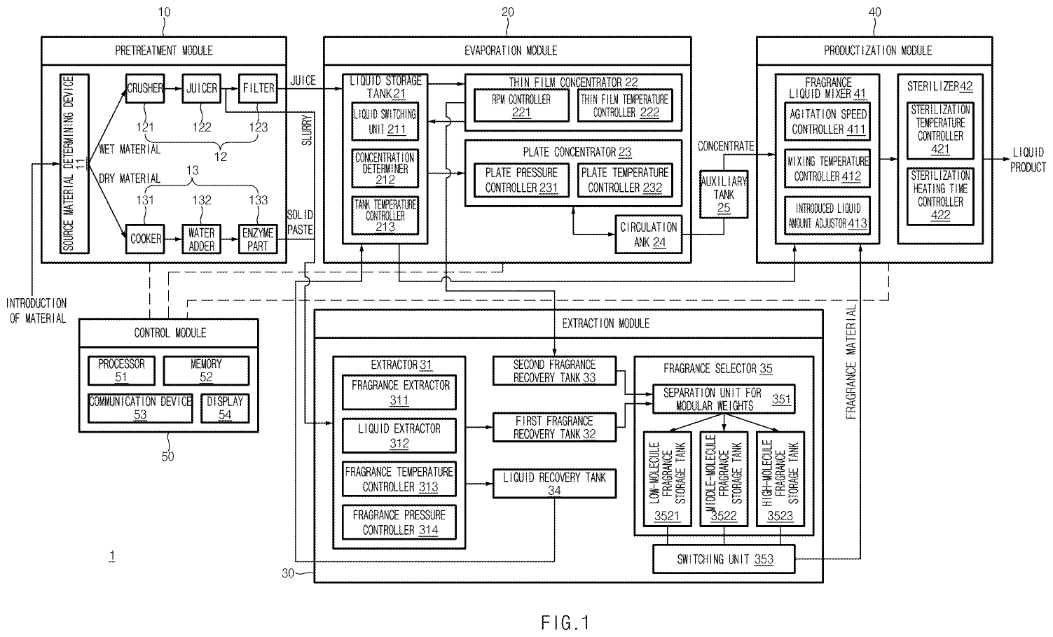

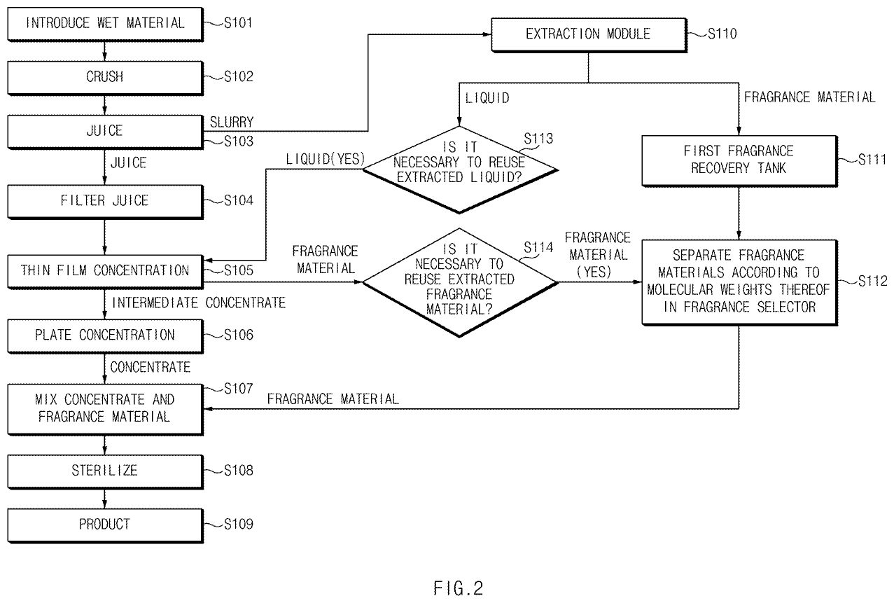

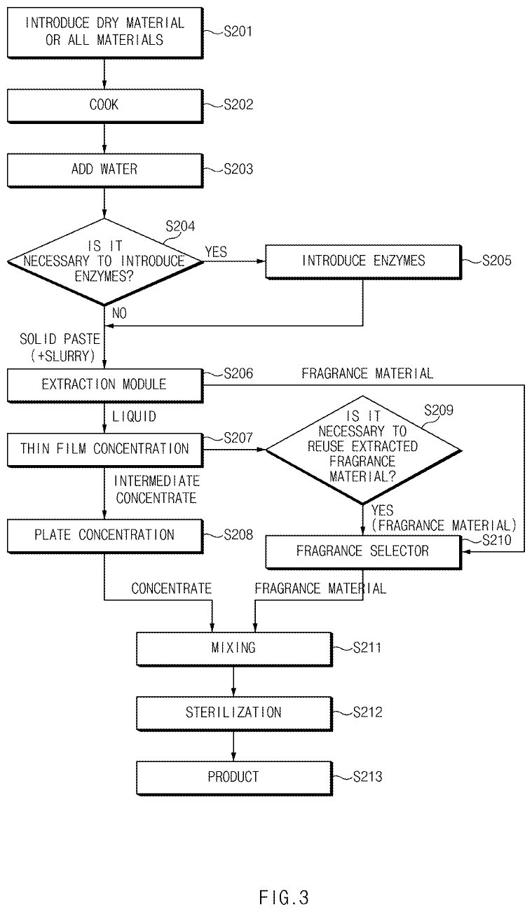

FIG. 1 is a conceptual view of a system for manufacturing concentrate according to an embodiment of the present invention. FIG. 2 is a view illustrating flows of a process of treating the wet material in a system for manufacturing concentrate according to an embodiment of the present invention. FIG. 3 is a view illustrating flows of a process of treating a dry material or all materials in a system for manufacturing concentrate according to an embodiment of the present invention.

Referring to the drawings, a system 1 for manufacturing a liquid product according to an embodiment of the present invention may include a pretreatment module 10, an evaporation module 20, an extraction module 30, and a productization module 40, and may include a control module 50.

Pretreatment Module 10

The pretreatment module 10 is a module that separates an wet material and a dry material from a material that is introduced and treats the wet material and the dry material. The wet material and the dry material are separated in the pretreatment module 10, and are treated such that they are easily treated in the evaporation module 20 and the extraction module 30. The pretreatment module 10 may include a feeding conveyor such the introduced material is treated while being fed to the pretreatment module 10.

The pretreatment module 10 may include a source material determining device 11 that receives a material and determines whether the introduced material is a dry material or an wet material. The source material determining device 11 may classify the introduced material into an wet material and a dry material by irradiating electromagnetic waves or applying a current to the introduced material. Here, the wet material refer to a material having a content of moisture of a specific value or more, and the dry material refers to a material having a content of moisture of less than the specific value. Examples of the wet material are vegetables and fruits, and examples of the dry material are dried fish and meat. Here, the specific value may be 10%.

Furthermore, the source material determining device 11 may include an optical system and an image sensor. In this case, the source material determining device 11 may recognize the introduced material, may find a corresponding item in a list of wet materials and dry materials, which is stored in advance, and may classify the introduced material into an wet material or a dry material.

The pretreatment module 10 may include an wet material treating device 12 that treats the wet material separated by the source material determining device 11, and a dry material treating device 13 that treats the dry material separated by the source material determining device 11.

The wet material from the introduced material are introduced into the wet material treating device 12 (S101). The wet material treating device 12 generates juice and slurry by treating the wet material separated by the source material determining device 11. To treat the wet material, the wet material treating device 12 may include a crusher 121, a juicer 122, and a filter 123.

The crusher 121 receives materials of wet material from the source material determining device 11 and crushes them (S102). To carry out the crushing, the crusher 121 may have a plurality of rotors that are rotated while being engaged with each other or may have a container, into which the materials are introduced, and crusher blades that are rotated in the container, but the method of crushing the wet material are not limited thereto.

The juicer 122 receives the wet material crushed by the crusher 121, and juices the wet material to generate unfiltered juice and slurry (S103). The juicer 122 is formed to press the wet material, and may include an apparatus that further adds water for smooth juicing. The filtered slurry is delivered to the extraction module 30.

The filter 123 obtains juice by filtering the unfiltered juice generated by the juicer 122 (S104). Accordingly, the filter 123 may include a porous filter, through which particles of a specific size or more cannot pass. The filter 123 causes the unfiltered juice to pass through the filter and delivers the juice that has passed to the evaporation module 20, which will be described below, and the further filtered slurry may be delivered to the extraction module 30, which will be described below.

The dry material or all the materials may be introduced into the dry material treating device 13 (S201). The dry material treating device 13 generates juice and slurry by treating the wet material separated by the source material determining device 11. The dry material treating device 13 may include a cooker 131 and a water adder 132, and may further include an enzyme part 133.

The cooker 131 receives the dry material from the source material determining device 1 and cooks the dry material by heating it (S202). The cooker 131 may not only heat the dry material but also may make the tastes of the dry material various by adding other materials. Because the dry material is heated in the cooker 131 through roasting, grilling, and the like, fragrance may be implemented as a cooking feeling is given to the dry material and tastes and flavors are given to the dry material due to a caramel reaction, a Mailyard reaction, and the like.

The water adder 132 generates solid paste by adding water to the cooked dry material. The solid paste may be delivered to the extraction module 30 immediately after passing though the water adder 132. However, when it is determined that it is necessary to introduce enzymes (S204), the enzymes may be further applied to the solid paste by the enzyme part 133 (S205). The enzymes applied by the enzyme part 133 are provided to increase an extraction efficiency of a fragrance material. The solid paste enzyme-treated by the enzyme part 133 is delivered to the extraction module 30.

Evaporation Module 20

The evaporation module 20 is a module that generates concentrate by concentrating the juice. To generate the concentrate by concentrating the juice obtained by treating the wet material in the pretreatment module 10, the evaporation module 20 may include a thin film concentrator 22 and a plate concentrator 23, and may further include a liquid storage tank 21, a circulation tank 24, a circulation concentration determiner, and an auxiliary tank 25.

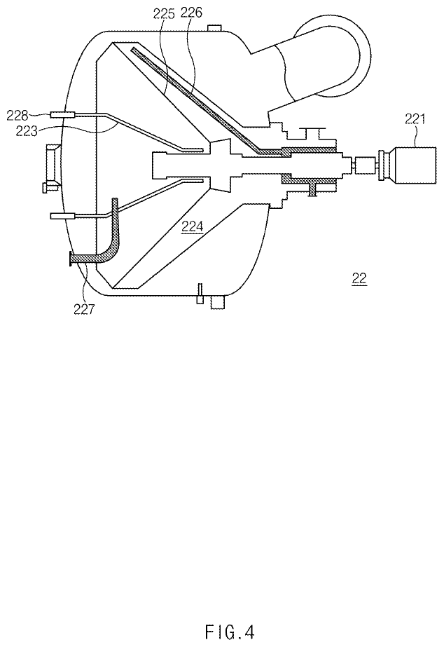

The thin film concentrator 22 may be a concentrator that forms intermediate concentrate by concentrating the juice in a scheme of forming a thin film by heating the juice (S105 and S107). The juice may be delivered from the pretreatment module 10 to the liquid storage tank 21 first, and may be delivered from the liquid storage tank 21 to the thin film concentrator 22. A configuration of the thin film concentrator 22 for generating the intermediate concentrate by concentrating the juice will be described in detail in a description of FIG. 4.

The thin film concentrator 22 may deliver the fragrance material generated in a process of forming the intermediate concentrate to the extraction module 30. The thin film concentrator 22 may be connected to a second fragrance recovery tank 33, and may deliver the fragrance material when it is necessary to reuse the fragrance material extracted by the thin film concentrator 22 (S114 and S209).

The liquid storage tank 21 may include a tank temperature controller 213. The tank temperature controller 213 may cool a liquid stored in the liquid storage tank 21 to minimize exposure of the liquid to the heat.

The liquid storage tank 21 may include a concentration determiner 212. The concentration determiner 212 is an element that acquires a concentration of the intermediate concentrate stored in the liquid storage tank 21. A concentration acquired by the concentration determiner 212 may be a brix concentration, but the concentration is not limited thereto.

A processor 51 may control the intermediate concentrate generated by the thin film concentrator 22 to be delivered to the liquid storage tank 21. The processor 51 may control the intermediate concentrate stored in the liquid storage tank 21 to recirculate to the thin film concentrator 22 when the concentration acquired by the concentration determiner 212 is less than a specific pass concentration. The processor 51 may control the intermediate concentrate stored in the liquid storage tank 21 to be delivered to the plate concentrator 23 when the concentration acquired by the concentration determiner 212 is the specific pass concentration or more. The liquid storage tank 21 may include a liquid switching unit 211 used to change a path of the intermediate concentrate. The liquid switching unit 211 may be controlled by the processor 51 such that the returning intermediate concentrate faces the thin film concentrator 22 or faces the plate concentrator 23.

The concentration determiner 212 may calculate a ratio of a weight of the intermediate concentrate that have been recovered after being concentrated to a weight of the juice or the intermediate concentrate initially delivered to the thin film concentrator 22, cause the intermediate concentrate to recirculate before the ratio reaches a specific value, and control the intermediate concentrate to be delivered to the plate concentrator 23 when the ratio reaches the specific value.

The plate concentrator 23 is a concentrator that generates the concentrate (S106 and S208) by further concentrating the intermediate concentrate concentrated by the thin film concentrator 22 in a scheme of exchanging heat of the intermediate concentrate with a plurality of plates 233 while the intermediate concentrate passes between the plurality of plates 233. The intermediate concentrate may be delivered to the plate concentrator 23 when a specific condition is satisfied after being stored in the liquid storage tank 21.

The concentrate may be generated by further concentrating the intermediate concentrate in the plate concentrator 23, but the concentrate obtained by further concentrating the intermediate concentrate in the thin film concentrator 22 while the intermediate concentrate does not pass through the plate concentrator 23 may be directly delivered from the liquid storage tank 21 to the productization module 40 to be described below.

The plate concentrator 23 may include a plate pressure controller 231 and a plate temperature controller 232. The plate pressure controller 231 is a part that further performs concentration as the plate concentrator 23 has a temperature that is suitable for concentration in the plate concentrator 23. The plate pressure controller 231 may lower a pressure of the plate concentrator 23 to lower a boiling point of moisture. The plate temperature controller 232 may control a temperature of the plate concentrator 23 to a temperature that is suitable for concentration in the plate concentrator 23. A temperature, at which evaporation occurs in the plate concentrator 23 controlled by the plate temperature controller 232 may be the same as a temperature, at which evaporation occurs in the thin film concentrator 22. According to the control, a quality of the generated concentrate may be maintained without being damaged.

The evaporation module 20 may further include the circulation tank 24, and a circulation concentration determiner (not illustrated) that acquires the concentration of the concentrate stored in the circulation tank 24. The circulation tank 24 is a container, in which the concentrate concentrated by the plate concentrator 23 is temporarily stored when the concentrate is circulated to be further concentrated by the plate concentrator 23.

The circulation concentration determiner is an element that acquires the concentration of the concentrate stored in the circulation tank 24. A concentration acquired by the circulation concentration determiner may be a brix concentration, but the concentration is not limited thereto. The circulation concentration determiner may be disposed in the circulation tank 24.

The processor 51 may perform a control based on the concentration of the concentrate acquired by the circulation concentration determiner. In detail, when the concentration acquired by the circulation concentration determiner is less than a specific circulation concentration, the processor 51 may control the concentrate stored in the circulation tank 24 to recirculate to the plate concentrator 23. Furthermore, when the concentration acquired by the circulation concentration determiner is the specific circulation concentration or more, the processor 51 may control the concentrate stored in the circulation tank 24 to be delivered to the productization module 40. Accordingly, the concentrate may be concentrated while recirculating between the circulation tank 24 and the plate concentrator 23 until the concentration of the concentrate reaches a targeted circulation concentrate.

The concentrate that reached the targeted circulation concentration through the recirculation may be discharged from the circulation tank 24, and may be temporarily stored in the auxiliary tank 25. The auxiliary tank 25 included in the evaporation module 20 is a container that stores the generated concentrate and selectively delivers the concentrate to the productization module 40.

FIG. 4 is a view illustrating a structure of the thin film concentrator 22 according to an embodiment of the present invention.

Referring further to FIG. 4, a structure of the thin film concentrator 22 will be described. The thin film concentrator 22 according to an embodiment of the present invention may include an evaporation plate 225, a sprayer 223, and a vapor provider 224.

The evaporation plate 225 is an element that provides a surface, to which the juice or the intermediate concentrate is sprayed such that evaporation occurs, and may have a conical shape. The juice or the intermediate concentrate is sprayed to an inner surface of the evaporation plate 225 having the conical shape and heated to be evaporated, and thus a thin film may be formed on the inner surface of the evaporation plate 225 to have the conical shape. The evaporation plate 225 may be rotated about an axis that passes through an apex of the conical shape formed by the evaporation plate 225.

The sprayer 223 is an element that sprays the juice or the intermediate concentrate to the inner surface of the evaporation plate 225. The sprayer 223 may be disposed in an area that is adjacent to a center of the inner surface of the evaporation plate 225. The sprayer 223 may spray the juice or the intermediate concentrate to the area that is adjacent to the center of the inner surface of the evaporation plate 225 and spread the liquid sprayed while the evaporation plate 225 rotates to the inner surface of the evaporation plate 225 to form a state, in which a thin film is easily formed.

The vapor provider 224 is an element that provides vapor to an outer surface of the evaporation plate 225, causes heat discharged while vapor is concentrated to be applied to the evaporation plate 225, and causes the juice or the intermediate concentrate sprayed to the inner surface of the evaporation plate 225 to be evaporated. The juice or the intermediate concentrate may be evaporated and may be concentrated while forming the thin film. The condensate generated through the concentration of the vapor may flow to an outside as the evaporation plate 225 is rotated and thus may be collected by a condensate collection pipe 226 to be discharged.

The intermediate concentrate concentrated in a form of a thin film may be collected through an intermediate concentrate collection pipe 227 after the rotation of the evaporation plate 225 is stopped, and may be delivered to the liquid storage tank 21.

The thin film concentrator 22 may include a thin film temperature controller 222. The thin film temperature controller 222 may control a temperature, at which evaporation occurs in the evaporation plate 225. The thin film temperature controller 222 may control a pressure of the thin film concentrator 22 to control the boiling point of the moisture.

The thin film concentrator 22 may include an rpm controller 221 that controls rotation of the evaporation plate 225. The rpm controller 221 may include a motor connected to the evaporation plate 225, and the motor may rotate the evaporation plate 225. The rotation of the evaporation plate 225 may be controlled by controlling the number of rotations per unit time of the motor.

The thin film concentrator 22 may include a flow rate controller 228. The flow rate controller 228 may adjust a flow rate of the juice or the intermediate concentrate sprayed through the sprayer 223.

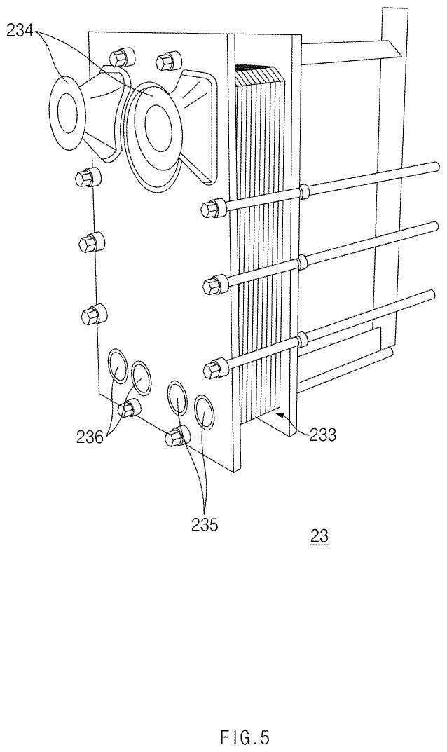

FIG. 5 is a perspective view of the plate concentrator 23 according to an embodiment of the present invention.

Referring further to FIG. 5, a structure of the plate concentrator 23 will be described. The plate concentrator 23 according to an embodiment of the present invention may include the plurality of plates 233, a plate inlet 235, a plate outlet 234, a thermal medium inlet, and a thermal medium outlet 236.

The plurality of plates 233, surfaces of which are engraved in a specific pattern, may be disposed in the plate concentrator 23 to overlap each other. As the plurality of plates 233 overlap each other, engraved portion on the surfaces thereof may form a plurality of passages. Along the passages, the thermal medium introduced into the plate concentrator 23 may flow or the intermediate concentrate or the concentrate may flow.

The plate inlet 235 is a part that guides the intermediate concentrate or the concentrate to the plurality of plates 233. Due to the plate inlet 235, the intermediate concentrate or the concentrate may pass through concentrate passages that are some parts of the plurality of passages. The plate inlet 235 may be connected to the liquid storage tank 21 and the circulation tank 24.

The plate outlet 234 is a part that discharges the concentrate that is further concentrated as the concentrate is evaporated while passing through the concentrate passage. The plate outlet 234 may be connected to the circulation tank 24.

The thermal medium inlet is a part that delivers a thermal medium of high temperature to thermal medium passages that are other parts of the plurality of passages formed by the plurality of plates 233. The thermal medium may flow through the thermal medium passage due to the thermal medium inlet, and the heat may be transferred to the intermediate concentrate or the concentrate that passes through the concentrate passage. That is, heat may be exchanged between the thermal medium and the intermediate concentrate or the concentrate through the plurality of plates 233. The thermal medium inlet may be the same as the plate outlet 234.

The thermal medium outlet 236 may be a part that guides the thermal medium to be discharged to an outside after the thermal medium flowing along the thermal medium passage transfers the heat to the intermediate concentrate or the concentrate.

Extraction Module 30

The extraction module 30 is a module that extracts the fragrance material from the slurry (S110), and further extracts the fragrance material from the solid paste (S206). Since the solid paste is obtained by treating the dry material in the pretreatment module 10, the extraction module 30 may extract the fragrance material only from the slurry obtained by treating the wet material when the dry material is not treated. The fragrance material is an expression that generally refers to a material including a fragrance substance, and may include essence or oil.

The extraction module 30 may include an extractor 31. The extractor 31 may include a fragrance extractor 311 and a liquid extractor 312. The extractor 31 may include a fragrance extractor 311 and a liquid extractor 312 when the extractor 31 is constituted by a distiller.

The extractor 31 may include a fragrance temperature controller 313 to control an operation temperature of the extractor 31, and the extractor 31 may include a fragrance pressure controller 314 to control an operation pressure of the extractor 31.

The extraction module 30 may include a first fragrance recovery tank 32 and a second fragrance recovery tank 33. The fragrance material obtained from the slurry or the solid paste through the extractor 31 may be stored in the first fragrance recovery tank 32. The fragrance material delivered from the thin film concentrator 22 of the evaporation module 20 may be stored in the second fragrance recovery tank 33.

The liquid extracted by the extractor 31 may be delivered to a liquid recovery tank 34. When it is determined that it is necessary to reuse the extracted liquid (S113), the liquid stored in the liquid recovery tank 34 may be selectively delivered to the liquid storage tank 21 of the evaporation module 20, and may be treated into the intermediate concentrate or the concentrate by the thin film concentrator 22 or the plate concentrator 23.

The extraction module 30 may include a fragrance selector 35. The fragrance materials stored in the first fragrance recovery tank 32 and the second fragrance recovery tank 33 may be delivered to the fragrance selector 35. The fragrance selector 35 is a system that separates the plurality of extracted fragrance materials and selectively delivers the extracted fragrance materials to the productization module 40 (S112 and S210). The fragrance selector 35 may include a separation unit 351 for molecular weights, a fragrance storage tank, and a switching unit 353.

The separation unit 351 for molecular weights is a part that receives the fragrance materials from the first fragrance recovery tank 32 and the second fragrance recovery tank 33 and separates the plurality of extracted fragrance materials according to the molecular weights thereof. The fragrance selector 35 may include a chromatography device for identifying the molecular weights of the delivered fragrance materials, and, among the molecular weights, the molecular weights corresponding to the materials including fragrance components may be identified. The separation unit 351 for molecular weights may include a plurality of membrane separators to separate the fragrance materials according to the molecular weights thereof through a membrane separation, by using reverse osmosis.

The plurality of fragrance storage tanks are containers that separate the fragrance materials that have been separated according to the molecular weights thereof and store the fragrance materials. In the embodiment of the present invention, although it is illustrated that a low-molecule fragrance storage tank 3521, a middle-molecule fragrance storage tank 3522, and a high molecule fragrance storage tank 3523, in which low molecules, middle molecules, and high molecules are separated by the separation unit 351 for molecular weights according to the molecular weights thereof are separated and stored, are disposed, the number of the fragrance storage tanks is not limited thereto, and sections, in which the fragrance materials are divided according to the molecular weights also may be modified according to situations.

The fragrance selector 35 may include the switching unit 353. The switching unit 353 is an element that selectively delivers the fragrance materials stored in the plurality of fragrance storage tanks, respectively, to the productization module 40. Accordingly, the switching unit 353 may include pipelines that connect the fragrance storage tanks and a fragrance liquid mixer 41 of the productization module 40, which will be described below, and a valve that selectively opens and closes a portion of the pipeline connected to the pipelines connected to the fragrance storage tanks. The switching unit 353 may be controlled by the processor 51 to selectively deliver a fragrance material of a necessary molecular weight to the productization module 40 and interrupt the other fragrance material from being delivered.

Productization Module 40

The productization module 40 is a module that generates a liquid product by mixing the concentrate and the fragrance materials. The productization module 40 may include the mixer 41 and a sterilizer 42.

The mixer 41 is an apparatus that agitates and mixes the concentrate delivered from the evaporation module 20, and the fragrance materials delivered from the extraction module 30 (S107 and S211). The mixer 41 may include an agitation speed controller 411, a mixing temperature controller 412, and an introduced liquid amount adjustor 413.

The introduced liquid amount adjustor 413 may determine a mixing ratio of an amount of used concentrate delivered from the evaporation module 20 and an amount of used fragrance material delivered from the extraction module 30. The concentrate and the fragrance material introduced by the introduced liquid amount adjustor 413 at a specific mixing ratio may be mixed by an agitator of the mixer 41. The agitator may include an agitation tank, into which the concentrate and the fragrance material are introduced, and agitation wings that agitate the materials while being rotated in the agitation tank.

The mixing temperature controller 412 is a part that controls a temperature of the agitation tank such that a temperature, by which agitation may be easily occur, is created in the agitator. The concentrate and the fragrance material may be preheated by the mixing temperature controller 412.

The agitation speed controller 411 may control an operation speed of the agitation wings. A viscosity of the concentrate may be adjusted according to control of the agitation speed controller 411, and the concentrate may be emulsificated.

The concentrate and the fragrance material may be mixed by the mixer 41, and a preliminary product may be produced. The preliminary product may be delivered to the sterilizer 42. The sterilizer 42 sterilizes the preliminary product mixed by the mixer 41 by applying heat to the preliminary product. The sterilizer 42 may sterilize the preliminary product by using ultrahigh temperature (UHT) sterilization. The sterilizer 42 may include a sterilization temperature controller 421 that controls temperature during the sterilization, and a sterilization heating time controller 422 that controls a time, at which the sterilization is performed. Accordingly, the liquid product may be generated from the preliminary product (S109 and S213).

Control Module 50

The control module 50 is an element for controlling the system 1 for manufacturing the liquid product. The control module includes the processor 51. The processor 51 is an element that is electrically connected to the other elements of the system 1 for manufacturing the liquid product to control the other elements. In particular, the processor 51 may be electrically connected to the evaporation module 20 to perform a control such that the intermediate concentrate or the concentrate concentrated in the concentrators circulates or proceeds to the next operation according to the concentrations thereof.

The processor 51 may include a microprocessor such as a field programmable gate array (FPGA), an application specific integrated circuit (ASIC), or a central processing unit (CPU), but the kind of the calculation device is not limited thereto.

The control module 50 may include a memory 52 that stores a plurality of control instructions that are bases for generating instructions for controlling the instructions by the processor 51. The processor 51 may be programmed to receive control instructions from the memory 52 and generate electrical signals for controlling the elements based on the control instructions. The memory 52 may be data storage such as a hard disk drive (HDD), a solid state drive (SSD), a volatile medium, or a nonvolatile medium, but the kind of the memory is not limited thereto.

The control module 50 may include a communication device 53. The communication device 53 is an element that is disposed to communicate with other elements of the system 1 for manufacturing the liquid product, or to communicate another communication device located on an outside of the system. The communication device 53 may include a modem for communication, and may transmit and receive information. The communication device 53 may be a wireless modem that may perform communication through a scheme of Wi-Fi, Bluetooth, and the like, and the communication scheme may be performed by using a sensor including an IR light emitter and a light receiver, but the configuration thereof is not limited thereto.

The control module 50 may include a display 54 that displays specific information. The display 54 may be electrically connected to the processor 51, and may display state information delivered to the processor 51 in a form of an electrical signal by the other elements included in the system 1 for manufacturing the liquid product such that a user may identify the state information. Furthermore, the display 54 may include a touchscreen to receive an instruction for control of the user, and the input instruction may be delivered to the processor 51 for a control.

Although it may have been described until now that all the elements constituting the embodiments of the present invention are coupled to one or coupled to be operated, the present invention is not essentially limited to the embodiments. That is, without departing from the purpose of the present invention, all the elements may be selectively coupled into one or more elements to be operated. Furthermore, because the terms, such as “comprising”, “including”, or “having” may mean that the corresponding element may be included unless there is a specially contradictory description, it should be construed that another element is not extruded but may be further included. In addition, unless defined otherwise, all terms used herein, including technical or scientific terms, have the same meanings as those generally understood by those skilled in the art to which the present invention pertains. The terms, such as the terms defined in dictionaries, which are generally used, should be construed to coincide with the context meanings of the related technologies, and are not construed as ideal or excessively formal meanings unless explicitly defined in the present invention.

The above description is a simple exemplification of the technical spirits of the present invention, and the present disclosure may be variously corrected and modified by those skilled in the art to which the present invention pertains without departing from the essential features of the present invention. Accordingly, the embodiments disclosed in the present invention is not provided to limit the technical spirits of the present invention but provided to describe the present invention, and the scope of the technical spirits of the present invention is not limited by the embodiments. Accordingly, the technical scope of the present invention should be construed by the attached claims, and all the technical spirits within the equivalent ranges fall within the scope of the present invention.

1. A system for manufacturing a liquid product, the system comprising:
a pretreatment module configured to treat a material that is introduced;
an evaporation module configured to generate concentrate by concentrating juice obtained by treating an wet material included in the introduced material in the pretreatment module;
an extraction module configured to extract a fragrance material from slurry further obtained by treating the wet material in the pretreatment module; and
a productization module configured to generate the liquid product by mixing the concentrate and the fragrance material.

2. The system of claim 1, wherein the evaporation module includes:
a thin film concentrator configured to form intermediate concentrate by heating the juice and concentrating the juice through a scheme of forming a thin film; and
a plate concentrator configured to generate the concentrate by further concentrating the intermediate concentrate concentrated in the thin film concentrator in a scheme of exchanging heat of the intermediate concentrate with a plurality of plates while causing the intermediate concentrate to pass between the plurality of plates.

3. The system of claim 2, further comprising:
a processor configured to control the evaporation module,
wherein the evaporation module further includes:
a circulation tank; and
wherein the evaporation module further includes a circulation concentration determiner configured to acquire a concentration of the concentrate stored in the circulation tank, and
wherein the processor is configured to:
control the concentrate generated by the plate concentrator to be delivered to the circulation tank;
when the concentration of the concentrate acquired by the circulation concentration determine is less than a specific circulation concentration, control the concentrate stored in the circulation tank to recirculate to the plate concentrator; and
when the concentration of the concentrate acquired by the circulation concentration determine is the specific circulation concentration or more, control the concentrate stored in the circulation tank to be delivered to the productization module.

4. The system of claim 2, further comprising:
a processor configured to control the evaporation module,
wherein the evaporation module further includes:
a liquid storage tank,
wherein the liquid storage tank includes:
a concentration determiner configured to acquire a concentration of the stored intermediate concentrate, and
wherein the processor is configured to:
control the intermediate concentrate generated by the thin film concentrator to be delivered to the liquid storage tank;
when the concentration of the concentrate acquired by the concentration determiner is less than a specific pass concentration, control the intermediate concentrate stored in the liquid storage tank to recirculate to the thin film concentrator; and
when the concentration of the concentrate acquired by the concentration determiner is the specific pass concentration or more, control the intermediate concentrate stored in the liquid storage tank to be delivered to the plate concentrator.

5. The system of claim 2, wherein the thin film concentrator delivers the fragrance material generated while the intermediate concentrate is formed to the extraction module.

6. The system of claim 2, wherein the thin film concentrator includes:
an evaporation plate having a conical shape;
a sprayer configured to spray the juice or the intermediate concentrate to an inner surface of the evaporation plate; and
a vapor provider configured to heat the evaporation plate by providing vapor to an outer surface of the evaporation plate such that the juice or the intermediate concentrate sprayed to the evaporation plate is evaporated to be concentrated while forming the thin film.

7. The system of claim 2, wherein the plate concentrator includes:
the plurality of plates configured to form a plurality of passages;
a plate inlet configured to guide the intermediate concentrate or the concentrate to the plurality of plates such that the intermediate concentrate or the concentrate passes through concentrate passages that are some parts of the plurality of passages;
a thermal medium inlet configured to deliver a thermal medium of high temperature to thermal medium passages that are other parts of the plurality of passages for transferring heat to the intermediate concentrate or the concentrate that passes through the concentrate passages; and
a plate outlet configured to discharge the concentrate that is further concentrated as the concentrate is evaporated while passing through the concentrate passages.

8. The system of claim 1, wherein the evaporation module further includes:
an auxiliary tank configured to store the generated concentrate and selectively deliver the concentrate to the productization module.

9. The system of claim 1, wherein the evaporation module further includes a fragrance selector including a separation unit for molecular weights configured to separate the plurality of extracted fragrance materials according to molecular weights thereof, a plurality of fragrance storage tank configured to separate the fragrance materials separated according to the molecular weights thereof and store the separated fragrance materials, and a switching unit configured to selectively deliver the fragrance materials stored in the plurality of fragrance storage tanks to the productization module.

10. The system of claim 9, wherein the separation unit for molecular weights separates the fragrance materials according to the molecular weights thereof by using a reverse osmosis scheme.

11. The system of claim 1, wherein the extraction module includes:
an extractor including a fragrance extractor configured to extract the fragrance material from the slurry, and a liquid extractor configured to extract a liquid material from the slurry, and
a liquid recovery tank configured to store the liquid material extracted by the liquid extractor and selectively deliver the stored liquid material to the evaporation module.

12. The system of claim 1, wherein the pretreatment module includes:
a source material determining device configured to separate the introduced material into the wet material and a dry material by irradiating electromagnetic waves or apply a current to the introduced material;
an wet material treating device configured to generate the juice and the slurry by treating the wet material separated by the source material determining device; and
a dry material treating device configured to generate solid paste by treating the dry material separated by the source material determining device.

13. The system of claim 12, wherein the wet material treating device includes:
a crusher configured to crush the wet material;
a juicer configured to generate the slurry and unfiltered juice by extracting juice from the crushed wet material; and
a filter configured to obtain the juice by filtering the unfiltered juice.

14. The system of claim 12, wherein the dry material treating device includes:
a cooker configured to cook the dry material by heating the dry material; and
a water adder configured to generate the solid paste by applying water to the cooked dry material.

15. The system of claim 14, wherein the dry material treating device further includes:
an enzyme part configured to apply enzymes to the solid paste.

16. The system of claim 1, wherein the productization module includes:
a mixer configured to mix the concentrate delivered from the evaporation module and the fragrance material delivered from the extraction module by agitating the concentrate and the fragrance material.

17. The system of claim 16, wherein the productization module further includes:
a sterilizer configured to sterilize a preliminary product obtained through the mixing of the mixer by applying heat to the preliminary product.

18. The system of claim 1, wherein the pretreatment module separates the wet material and a dry material further included in the introduced material to treat the wet material and the dry material, and
wherein the extraction module further extracts the fragrance material from a solid paste obtained by treating the dry material.

19. An evaporation module for concentrating juice obtained from the wet material into concentrate for producing a liquid product, the evaporation module comprising:
a thin film concentrator configured to form intermediate concentrate by heating the juice and concentrating the juice through a scheme of forming a thin film; and
a plate concentrator configured to generate the concentrate by further concentrating the intermediate concentrate concentrated in the thin film concentrator in a scheme of exchanging heat of the intermediate concentrate with a plurality of plates while causing the intermediate concentrate to pass between the plurality of plates.
